(19) United States
(12) Patent Application Publication
(10) Pub. No.: US 2012/0134641 A1
(43) Pub. Date: May 31, 2012

(54) Electronic Apparatus and Method of Displaying Bar

(76) Inventor: Yuki Kanbe, Ome City (JP)

(21) Appl. No.: 13/240,977

(22) Filed: Sep. 22, 2011

(30) Foreign Application Priority Data
Nov. 26, 2010 (JP) 2010-263925

(51) Int. Cl. H04N 5/775

(52) U.S. Cl. 386/230; 386/E05.07

(57) ABSTRACT

An electronic apparatus includes a display device and a controller configured to display: a first bar configured to be displayed on the display device in a manner that a reproduction position of contents under reproduction is configured to be designated by touching; and a second bar configured to, if the display device on which the first bar is displayed is touched, be displayed on the display device so that the reproduction position of the contents under reproduction is displayed to be designatable in a visually finer manner than the display of the first bar.

### CROSS REFERENCE TO RELATED APPLICATION(S)

The present disclosure relates to the subject matters contained in Japanese Patent Application No. 2010-263925 filed on Nov. 26, 2010, which are incorporated herein by reference in its entirety.

### FIELD

An embodiment of the present invention relates to an electronic apparatus which displays a seek bar to be displayed on a reproduction screen of audio/motion picture reproduction software.

### BACKGROUND

Presently, electronic apparatuses are widely spread which have a function of displaying a seek bar having a bar-like display area on a reproduction screen for contents such as audio/motion picture reproduction software, so that the current reproduction position of the audio/motion picture reproduction software or the like can be displayed and changed.

Usually, a seek bar displays a reproduction point of contents such as music/motion picture reproduction software.

A seek bar is displayed on a display screen, for example, below a reproduction screen of contents, and has a horizontally elongated bar-like area. As reproduction proceeds, a knob-like operating portion (slider) which is displayed in the left end of the display screen is further moved toward the right end.

The length of the seek bar displayed on the screen indicates the reproduction time of the whole contents which are being reproduced. From the position of the slider, it is possible to visually know the current reproduction position which exists in the range from the beginning to the end of contents such as a music piece or a motion picture. When the slider is dragged to be laterally moved, contents can be reproduced from an arbitrary portion at which the dragging movement reaches.

In the case where a motion picture of five minutes duration is reproduced, when the slider is positioned just at the intermediate position, for example, it is indicated that the reproduction position (reproduction elapsed time) is at the timing of two and a half minutes. When an arbitrary location in the seek bar is clicked, reproduction can be started from the location.

As described above, the length of the seek bar displayed on the screen indicates the reproduction time of the whole contents under reproduction. In an electronic apparatus which displays a seek bar, therefore, it is usual that the seek bar is displayed in the substantially same length for both contents of a long reproduction time and those of short reproduction time.

For example, when seek bars of the same length are assumed to be displayed, in a seek bar for contents of a long reproduction time, however, the changing distance of the reproduction position with respect to the moving distance of the slider is relatively long as compared to that for contents of a short reproduction time.

For example, a seek bar for contents of a reproduction time of 100 minutes, and that for contents of a reproduction time of 1 minute are compared with each other. The case where a slider is moved on the screen by a length of a half of a seek bar will be considered. In the seek bar for the reproduction time of 100 minutes, the changing distance of the reproduction position corresponds to a long changing time of 50 minutes, but, in that for the reproduction time of 1 minute, the changing distance of the reproduction position corresponds to a short changing time of 30 seconds.

In other words, when adjustment of the reproduction position by a seek bar for contents of a long reproduction time is compared with that by a seek bar for contents of a short reproduction time, the adjustment by the seek bar for contents of a long reproduction time is performed coarsely and a fine adjustment is hardly performed. In contrast, the adjustment by the seek bar for contents of a short reproduction time is minutely performed and a fine adjustment can be performed.

Therefore, particularly in the case of contents of a long reproduction time, it may be difficult for the user to finely adjust the reproduction position.

In the case of contents of a short reproduction time, similarly, when a seek bar is displayed in a small area, it may be difficult for the user to finely adjust the reproduction position.

Consequently, it has been requested to provide an electronic apparatus in which, in adjustment of a reproduction position of contents by using a seek bar, the user can easily perform fine adjustment.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a view showing the appearance of an example of an electronic apparatus (tablet PC) of an embodiment.

FIG. 2 is an exemplary block diagram showing the configuration of the electronic apparatus of the embodiment.

FIG. 3 is an exemplary view showing how a first seek bar is displayed on a video display portion in the electronic apparatus of the embodiment.

FIG. 4 is an exemplary view showing how the first seek bar is displayed on the video display portion in the electronic apparatus of the embodiment.

FIG. 5 is an exemplary view showing how the first seek bar and a second seek bar are displayed on a video display portion and operated by the user in the electronic apparatus of the embodiment.

FIG. 6 is an exemplary view showing how, in the case where the user designates the left side of the first seek bar in the electronic apparatus of the embodiment, the second seek bar is displayed in the left side.

FIG. 7 is a view showing another example showing how the first and second seek bars are displayed on the video display portion in the electronic apparatus of the embodiment.

FIG. 8 is an exemplary flowchart illustrating the operation of the electronic apparatus of the embodiment.

### DETAILED DESCRIPTION OF THE EMBODIMENTS

According to one embodiment, an electronic apparatus includes a display device and a controller. The controller is configured to display: a first bar configured to be displayed on the display device in a manner that a reproduction position of contents under reproduction is configured to be designated by touching; and a second bar configured to, if the display device on which the first bar is displayed is touched, be displayed on the display device so that the reproduction position of the contents under reproduction is displayed to be designatable in a visually finer manner than the display of the first bar.

Hereinafter, an embodiment will be described with reference to the drawings.

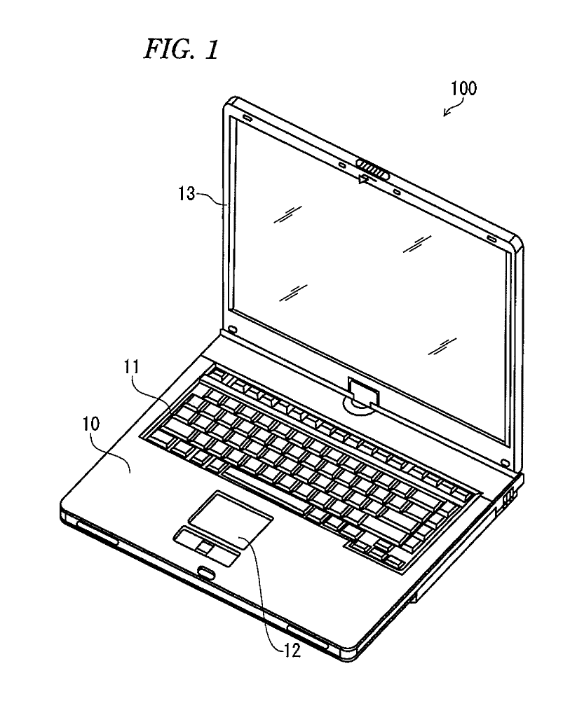

FIG. 1 is a view showing the appearance of an example of an electronic apparatus of the embodiment.

The reference numeral 10 denotes a computer body, the reference numeral 11 denotes a keyboard, the reference numeral 12 denotes a touchpad, the reference numeral 13 denotes a display device (touch screen display), and the reference numeral 100 denotes a tablet type personal computer (tablet PC).

Hereafter, as an example of the electronic apparatus of the embodiment, the tablet PC 100 will be described.

In the embodiment, the electronic apparatus 100 is not limited to a tablet PC. The embodiment may be applied also to an electronic apparatus including a touch panel, such as a smartphone or a slate terminal.

The electronic apparatus (tablet PC) 100 is a computer system which, as inputting devices, includes: the keyboard 11; the touchpad 12; and further the display device 13 that, on its surface, has a touch panel for detecting a coordinate position and the area of its contacting face of a pen or a finger.

In the tablet PC 100, as shown in FIG. 1, the keyboard 11 and the touchpad 12 are disposed on the computer body 10, and hardware having a block configuration which will be described later is incorporated in the computer body 10.

The display device 13 having a display panel (display screen) configured by an LCD, and a tablet (touch panel) which is disposed integrally on the surface of the display panel is attached openably, closably, and rotatably to the computer body 10 by a rotation dual-axis hinge mechanism.

FIG. 1 shows that the display device 13 is in a normal opened state (lap top mode). Also, the display device 13 can be set to a state where the display device is rotated by 180 degrees from the normal opened state and covers the keyboard 11 (tablet mode).

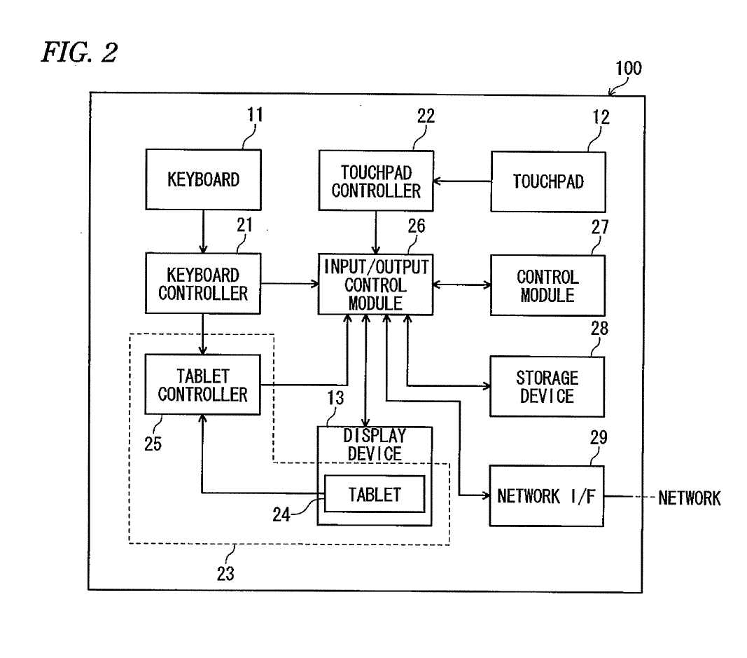

FIG. 2 is an exemplary block diagram showing the configuration of the electronic apparatus of the embodiment.

As shown in the figure, the tablet PC 100 includes a keyboard controller 21 which converts a key input at the keyboard 11 into input data, and which supplies the data to the computer body 10. The tablet PC 100 further includes a touchpad controller 22 which converts an operation input at the touchpad 12 into input data, and which supplies the data to the computer body 10.

In addition to the keyboard 11 and the touchpad 12, the tablet PC 100 further includes a tablet type input device 23 as a data input device. The tablet type input device 23 is configured by a tablet (touch panel) 24, and a tablet controller 25 which converts the coordinate position and the area of its contacting face of a pen or a finger that is detected by the tablet 24 into input data.

The computer body 10 further includes an input/output control module 26. The input/output control module 26 transfers the data which are supplied from the keyboard controller 21, the touchpad controller 22, and the tablet controller 25, to a microprocessor (CPU) included in a control module 27, and, in accordance with the control of the CPU, controls an output operation of the display device 13, and input/output operations of a storage device 28 such as an HDD or a Solid State Drive (SSD).

The control module 27 also includes a system memory configured by a RAM or the like into which an OS and various applications are loaded, and which is used as a work area, and memory devices such as a BIOS ROM.

A network I/F 29 which is connected to the input/output control module 26 is an interface for connection to an external server (not shown) through a network such as the Internet or a Local Area Network (LAN). The tablet PC 100 can download desired programs and contents from the external server or the like through the network I/F 29. Although the embodiment which uses a wireless LAN as the network will be described, the electronic apparatus may use a wired LAN.

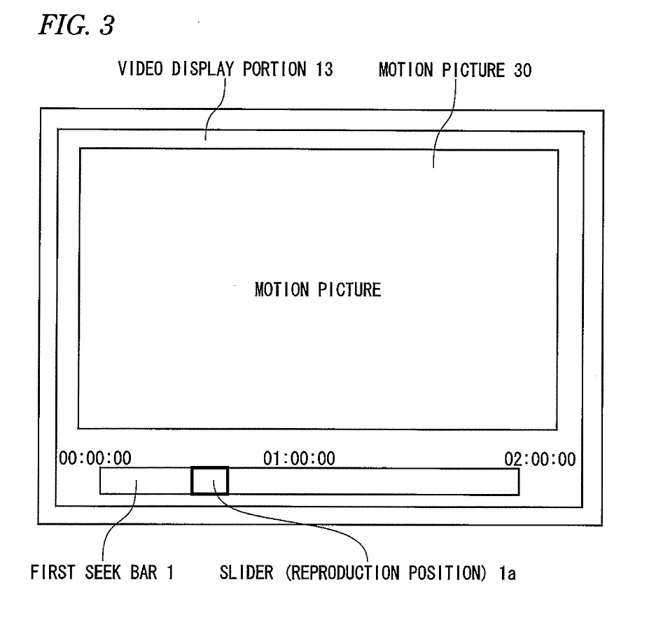

FIG. 3 is an exemplary view showing how a first seek bar is displayed on a video display portion in the electronic apparatus of the embodiment.

In the embodiment, the tablet (touch panel) is configured by a multi-touch panel, and simultaneously displays a plurality of seek bars as described later.

A multi-touch panel is a touch panel in which the user can simultaneously touch a plurality of points on the display screen to input data.

For example, a plurality of persons may touch a large display screen to perform collaborative work, or a plurality of fingers may simultaneously touch a display screen. Furthermore, for example, motions such as movement and rotation of an object, and zooming of an image can be intuitively input.

The reference numeral 1 denotes the fist seek bar, 30 denotes a motion picture, and the reference numeral 1a denotes a slider.

Here, contents such as music/motion picture reproduction software are displayed on a video display portion 13. The motion picture 30 is displayed as an example.

The first seek bar 1 related to the motion picture 30 is displayed below the screen of the motion picture 30.

In the example, reproduction start time “00:00:00” is displayed in the vicinity of the start end (left end) of the first seek bar 1, and reproduction end time “02:00:00” is displayed in the vicinity of the terminal end (right end). Furthermore, time “01:00:00” which is a half of the reproduction position is displayed in the vicinity of a middle portion (middle). From the difference between the reproduction time at the start end and that at the terminal end, it is seen that the reproduction time of the motion picture 30 is two hours.

The slider 1a is displayed on the first seek bar 1 with the slider 1a is overlapped on the first seek bar 1. As described above, the length of the first seek bar 1 which is displayed on the video display portion 13 indicates the reproduction time of the whole contents (motion picture 30) under reproduction, and the position of the contents where reproduction is being performed can be visually known from the position of the slider 1a. Here, it is known that the reproduction position is in front of reproduction position “01:00:00” which corresponds to a half of the contents (motion picture 30).

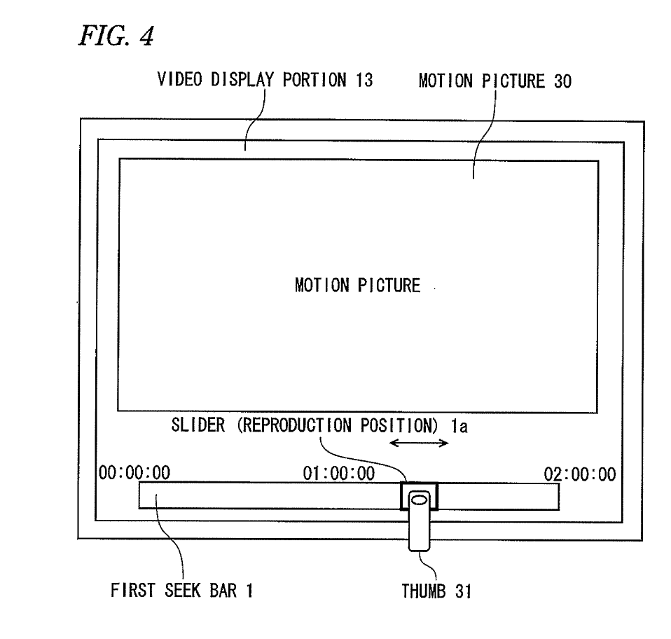

FIG. 4 is an exemplary view showing how the first seek bar is displayed on the video display portion in the electronic apparatus of the embodiment.

The reference numeral 31 denotes a finger of the user which, in the example, is the thumb.

The user directly touches the slider 1a which is superimposedly on the first seek bar 1, with the thumb 31, and laterally drags the slider 1a to a desired reproduction position of the first seek bar 1 while viewing the first seek bar 1 and the motion picture 30.

As described above, with respect to contents of a long reproduction time, the adjustment of the reproduction position in which a seek bar is used tends to be coarsely performed.

Here, the contents has a reproduction time of two hours as described above, the reproduction position is coarsely adjusted, and, in this state, the user hardly performs fine adjustment.

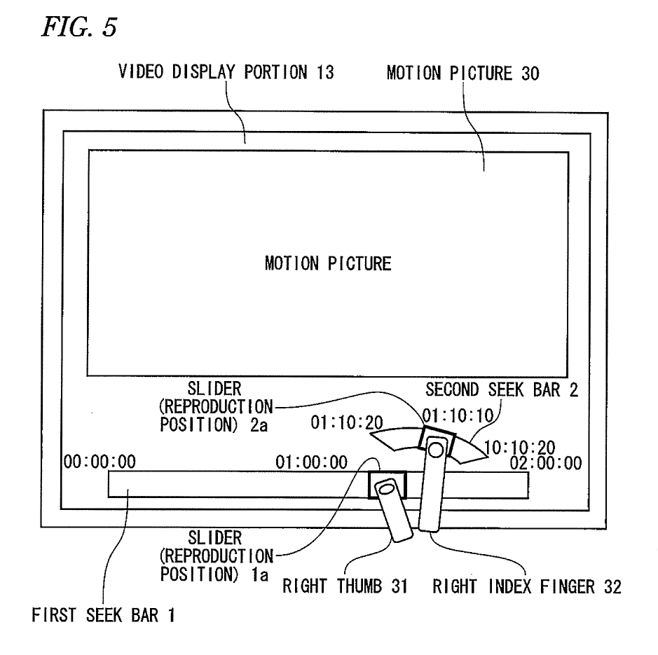

FIG. 5 is an exemplary view showing how the first seek bar and a second seek bar are displayed on a video display portion and operated by the user in the electronic apparatus of the embodiment.

The reference numeral 2 denotes the second seek bar, and the reference numeral 2a denotes a slider which is displayed superimposedly on the second seek bar, and which is similar to the slider 1a.

In the embodiment, when the user touches and designates the position in which reproduction or a change is to be performed in the first seek bar 1, with a first finger (for example, the right thumb) 31 as described above, the display of the slider 1a is moved to the position of the first seek bar 1 which the user touches, and the contents at the reproduction position is reproduced.

In this state, when the user touches the video display portion 13 with a second finger (for example, the right index finger) 32, the second seek bar 2 which is different from the first seek bar 1 is displayed on the video display portion 13.

The second seek bar 2 displays a seek bar indicating the vicinity of the reproduction position 1a where the first seek bar 1 is touched and designated by the first finger 31, and also displays in detail the vicinity of the reproduction position 1a.

Here, for example, the second seek bar 2 enlargedly displays the range from reproduction position “01:10:00” of the contents to reproduction position “01:10:20” (namely, from 1 hour 10 minutes 00 second to 1 hour 10 minutes 20 seconds), as compared to the first seek bar 1.

The second seek bar 2 is displayed in a shape which is not linearly, but rather displayed in an arcuate shape (curved or sector shape) which surrounds the slider 1a as shown in the figure.

The slider 2a is superimposed on the second seek bar 2, and displayed, for example, at reproduction position “01:10:10” which is the middle reproduction position of the second seek bar 2. In the figure, the right index finger 32 of the user touches the slider.

In this state, when the user releases the contacts of the right thumb 31 and the right index finger 32 with the video display portion 13, the contents are reproduced at this reproduction position “01:10:10”.

In the embodiment, the first seek bar 1 is displayed linearly and in a coarse manner from the view point of adjustment of the reproduction position, and the second seek bar 2 is displayed in the vicinity of the first seek bar 1 so as to indicate in detail the vicinity of the reproduction position 1a in an arcuate shape (curved or sector shape) which surrounds the slider 1a.

In the above-described configuration, in the case where the reproduction position of contents is to be adjusted by using a seek bar, the user can easily perform fine adjustment.

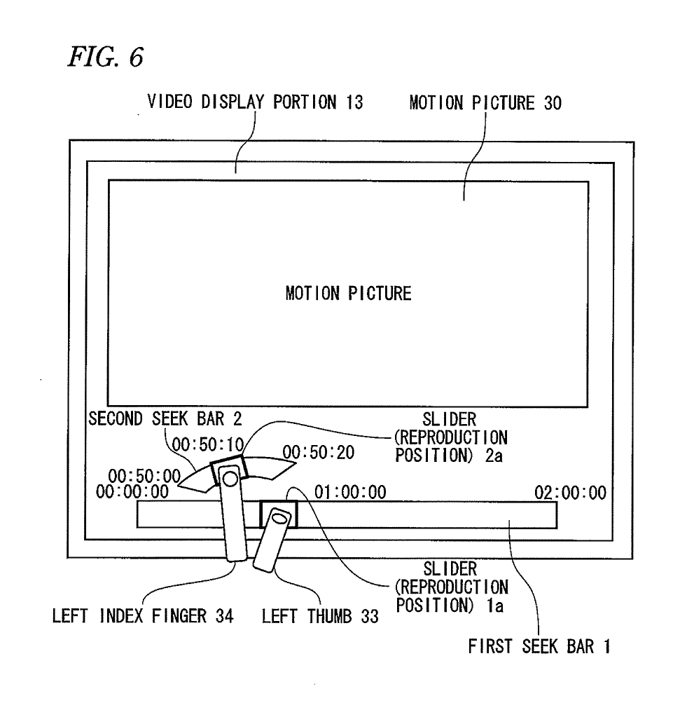

FIG. 6 is an exemplary view showing how, in the case where the user designates the left side of the first seek bar in the electronic apparatus of the embodiment, the second seek bar is displayed in the left side.

In the embodiment, the first finger is the left thumb 33, and the second finger is the left index finger 34, that is, in FIG. 6, fingers are switched as compared to FIG. 3.

In the case where the seek bar 1 and the seek bar 2 are to be operated by the left hand, when the seek bar 1 is operated by the left thumb 33, for an operational reason, the seek bar 2 is operated by the left index finger 34. In this case, usually, the operation is performed more easily in the configuration where the seek bar 2 is placed on the left side of the seek bar 1.

In a similar manner as described above, when the user touches and designates the position in which reproduction or a change is to be performed in the first seek bar 1, with a first finger (for example, the left thumb) 33, the display position of the slider 1a is moved, and the contents at the reproduction position (corresponding to the display position of the slider 1a) is reproduced.

In this state, when the user touches the video display portion 13 with a second finger (the left index finger) 34, the second seek bar 2 is displayed on the video display portion 13.

In a similar manner as described above, the second seek bar 2 displays a seek bar indicating the vicinity of the reproduction position 1a, and also displays in detail the vicinity of the reproduction position 1a.

Here, for example, the second seek bar 2 enlargedly displays the range from reproduction position “00:50:00” of the contents to reproduction position “00:50:20” (namely, from 0 hour 50 minutes 00 second to 0 hour 50 minutes 20 seconds), as compared to the first seek bar 1.

The second seek bar 2 has a shape which is similar to what described above.

The slider 2a is superimposed on the second seek bar 2, and displayed, for example, at reproduction position “00:50:10” which is the middle reproduction position of the second seek bar 2. In the figure, the left index finger 34 of the user touches the slider.

In this state, when the user releases the contacts of the left thumb 33 and the left index finger 34 with the video display portion 13, the contents are reproduced at this reproduction position “00:50:10”.

Also in the embodiment, in the case where the reproduction position of contents is to be adjusted by using a seek bar, the user can easily perform fine adjustment.

In the configuration where, when the display of the slider 1a is moved to the left half side of the first seek bar 1, the seek bar 2 is placed on the left side of the seek bar 1, the user can easily perform the fine adjustment.

In the configuration where, when the display of the slider 1a is moved to the right half side of the first seek bar 1, the seek bar 2 is placed on the right side of the seek bar 1, similarly, the user can easily perform the fine adjustment.

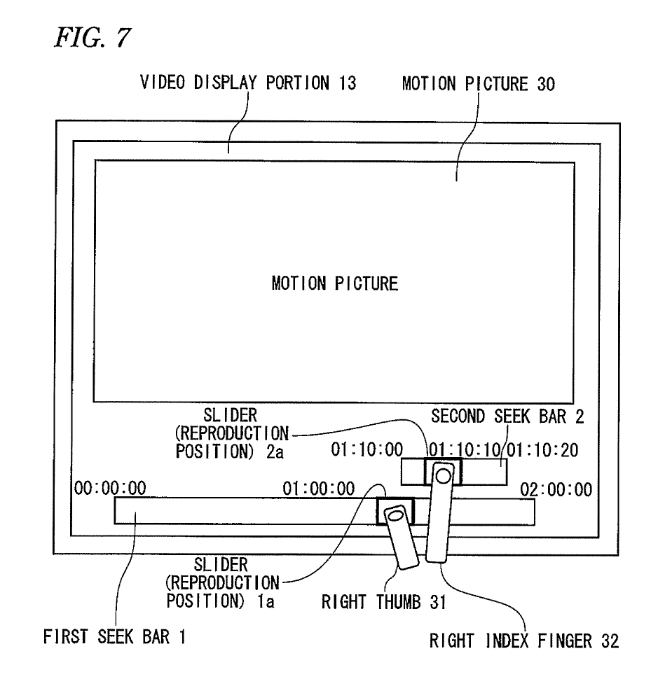

FIG. 7 is a view showing another example showing how the first and second seek bars are displayed on the video display portion in the electronic apparatus of the embodiment.

In the embodiment, unlike the above description, the second seek bar 2 is linearly displayed.

In a similar manner as described above, when the user touches and designates the position in which reproduction or a change is to be performed in the first seek bar 1, with the first finger (for example, the right thumb) 31, the display position of the slider 1a is moved, and the contents at the reproduction position (corresponding to the display position of the slider 1a) is reproduced.

In this state, when the user touches the video display portion 13 with the second finger (for example, the right index finger) 32, the second seek bar 2 which is different from the first seek bar 1 is displayed on the video display portion 13.

In a similar manner as described above, the second seek bar 2 displays a seek bar indicating the vicinity of the reproduction position 1a where the first seek bar 1 is touched and designated by the first finger 31, and also displays in detail the vicinity of the reproduction position 1a.

For example, the second seek bar 2 enlargedly displays the range from reproduction position “01:10:00” of the contents to reproduction position “01:10:20” (namely, from 1 hour 10 minutes 00 second to 1 hour 10 minutes 20 seconds), as compared to the first seek bar 1.

The slider 2a is superimposed on the second seek bar 2, and displayed, for example, at reproduction position “01:10:10” which is the middle reproduction position of the second seek bar 2. In the figure, the right index finger 32 of the user touches the slider.

In this state, when the user releases the contacts of the right thumb 31 and the right index finger 32 with the video display portion 13, the contents are reproduced at this reproduction position “01:10:10”.

In the above-described configuration, the second seek bar 2 is displayed in the vicinity of the first seek bar 1. In the case where the reproduction position of contents is to be adjusted by using a seek bar, therefore, the user can easily perform fine adjustment.

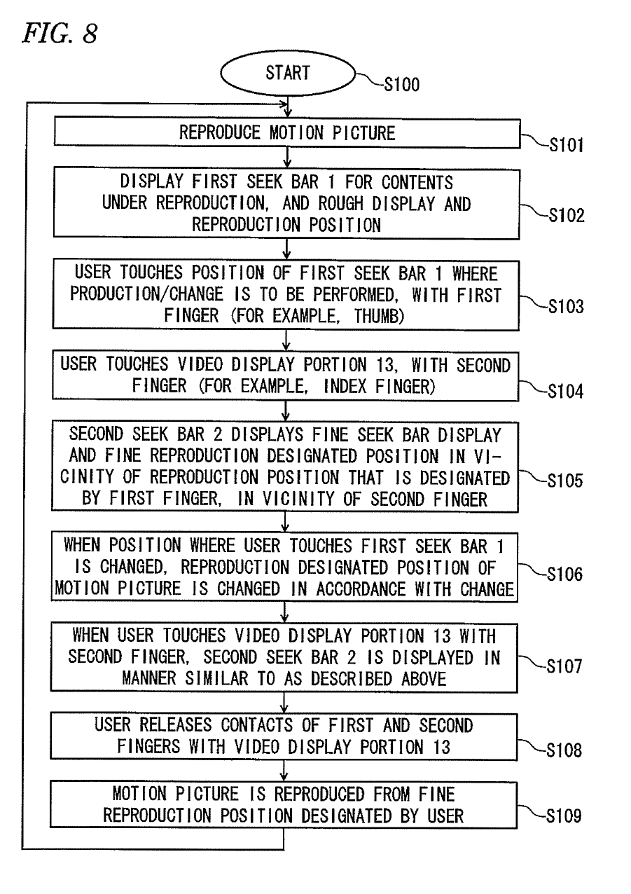

FIG. 8 is an exemplary flowchart illustrating the operation of the electronic apparatus of the embodiment.

The reference numeral S100 indicates the start step of the flow. Then, the process proceeds to step S101.

Step S101 is a step of reproducing contents. In the step, a motion picture is reproduced. Then, the process proceeds to step S102.

Step S102 is a step of displaying the first seek bar 1 for the contents under reproduction and a rough display and reproduction position indicated by the first seek bar 1. Then, the process proceeds to step S103.

Step S103 is a step in which the user touches the position of the first seek bar 1 where reproduction/change is to be performed, with the first finger (for example, a thumb). In accordance with the touch, for example, the slider 1a may be moved. Then, the process proceeds to step S104.

Step S104 is a step in which the user touches the video display portion 13, with the second finger (for example, an index finger). Then, the process proceeds to step S105.

Step S105 is a step in which the second seek bar 2 displays a fine seek bar display and fine reproduction designated position in the vicinity of the reproduction position that is designated by the first finger, in the vicinity of the second finger. Then, the process proceeds to step S106.

Step S106 is a step in which, when the position where the user touches the first seek bar 1 is changed, the reproduction designated position of the motion picture is changed in accordance with the change. Then, the process proceeds to step S107.

Step S107 is a step in which, when the user touches the video display portion 13 with the second finger, the second seek bar 2 is displayed in a manner similar to as described above. Then, the process proceeds to step S108.

Step S108 is a step in which the user releases the contacts of the first and second fingers with the video display portion 13. Then, the process proceeds to step S109.

Step S109 is a step in which the motion picture is reproduced from the fine reproduction position designated by the user. Then, the process returns to step S101, and the above-described processes are repeated.

As described above, the electronic apparatus of the embodiment includes the multi-touch panel, and the user simultaneously operates a plurality of seek bars such as the first seek bar 1 and the second seek bar 2.

Then, a seek bar such as the first seek bar 1 in which the changing distance of the reproduction position with respect to the moving distance of the slider is relatively long, and another seek bar such as the second seek bar 2 in which the changing distance is relatively short are displayed so that the seek bars are simultaneously operated in an easy manner by, for example, two fingers.

When, during an operation of the first seek bar 1 by the first finger in which the changing distance of the reproduction position with respect to the moving distance of the slider is long, the panel (video display portion 13) is touched by the second finger, moreover, a seek bar such as the second seek bar 2 in the changing distance is relatively short is displayed at the touched position.

For example, a case where the seek bars are operated by one hand will be considered. A seek bar such as the first seek bar 1 in which the changing distance of the reproduction position with respect to the moving distance of the slider is relatively long is linearly displayed, and a seek bar such as the second seek bar 2 in the changing distance is relatively short is displayed in an arcuate shape (curved or sector shape) or the like.

In the embodiment, a multi-touch panel is used, and a plurality of seek bars are displayed in different positions and shapes so that the user can simultaneously operate the plurality of seek bars in an easy manner, whereby the user is enabled to, in simultaneous operation of two kinds of seek bars on the multi-touch panel, easily perform the operation.

In the embodiment of the invention, according to the configuration, it is possible to provide an electronic apparatus in which, in adjustment of a reproduction position of contents by using a seek bar, the user can easily perform fine adjustment.

In the above, the electronic apparatus 100 has been described by exemplifying the case where the user uses the right thumb and the right index finger or the left thumb and the left index finger. However, the fingers used by the user are not limited to the thumb and the index finger, and the user may use any combination of fingers such as the index finger and the middle finger, or the thumb and the middle finger.

Objects which are to touch the multi-touch panel are not limited to fingers, and touch pens or the like may be used.

The shape of the second seek bar 2 is not limited to an arcuate shape (curved or sector shape) which has been described above, and may be a linear shape or the like.

The embodiment is not limited to the description as it is, and, in the stage of implementation, the invention can be embodied while the components are variously modified without departing the spirit of the invention.

What is claimed is:

1. An electronic apparatus comprising:
a display device; and
a controller configured to display:
a first bar configured to be displayed on the display device in a manner that a reproduction position of contents under reproduction is configured to be designated by touching; and
a second bar configured to, if the display device on which the first bar is displayed is touched, be displayed on the display device so that the reproduction position of the contents under reproduction is displayed to be designatable in a visually finer manner than the display of the first bar.

2. The electronic apparatus according to claim 1, wherein a changing amount of the reproduction position in the second bar is smaller than a changing amount of the reproduction position in the first bar.

3. The electronic apparatus according to claim 1, wherein the second bar includes a portion which is curvedly configured.

4. The electronic apparatus according to claim 1, wherein the second bar includes a portion which is configured in a sector shape.

5. The electronic apparatus according to claim 1, wherein the second bar is displayed smaller than the first bar.

6. The electronic apparatus according to claim 1, wherein the controller is configured to further display:
a first slider which, in the first bar, indicates the reproduction position of the contents under reproduction; and
a second slider which, in the second bar, indicates the reproduction position of the contents under reproduction, wherein the reproduction position of the contents indicated by the second slider is displayed in accordance with the reproduction position where the first slider is designated.

7. The electronic apparatus according to claim 6, wherein the first slider and the second slider are designated by touching the display device.

8. The electronic apparatus according to claim 1,
wherein the display device comprises a video display portion configured to display a video,
wherein the controller is configured to display the second bar if the video display portion is touched during reproduction of the contents.

9. The electronic apparatus according to claim 1, wherein, after the first bar and the second bar are displayed, if a contact with the second bar is released, the contents is reproduced from a reproduction position corresponding to a position where the contact is released.

10. The electronic apparatus according to claim 1, wherein the display device is a touch screen display.

11. A method of displaying a bar, the method comprising:
displaying, in a display device, a reproduction position of contents under reproduction in a manner that the reproduction position configured to be designated by touching a first bar; and,
if the display device on which the first bar is displayed is touched, displaying a second bar in a manner that the reproduction position of the contents under reproduction is displayed to be designatable in a visually finer manner than the display of the first bar.

12. The method according to claim 11, wherein a changing amount of the reproduction position in the second bar is smaller than a changing amount of the reproduction position in the first bar.

13. The method according to claim 11, wherein the second bar includes a portion which is curvedly configured.

14. The method according to claim 11, wherein the second bar includes a portion which is configured in a sector shape.

15. The method according to claim 11, wherein the second bar is displayed smaller than the first bar.

16. The method according to claim 11, further comprising displaying:
a first slider which, in the first bar, indicates the reproduction position of the contents under reproduction; and
a second slider which, in the second bar, indicates the reproduction position of the contents under reproduction, wherein the reproduction position of the contents indicated by the second slider is displayed in accordance with the reproduction position where the first slider is designated.

17. The method according to claim 16, wherein the first slider and the second slider are designated by touching the display device.

18. The method according to claim 11,
wherein the display device comprises a video display portion configured to display a video,
wherein the second bar is displayed if the video display portion is touched during reproduction of the contents.

19. The method according to claim 11, wherein, after the first bar and the second bar are displayed, if a contact with the second bar is released, the contents is reproduced from a reproduction position corresponding to a position where the contact is released.
